(19) United States
(12) Patent Application Publication
(10) Pub. No.: US 2016/0098096 A1
(43) Pub. Date: Apr. 7, 2016

(54) CONTROL USER INTERFACE FOR A POWERSPORTS VEHICLE

(71) Applicant: Warn Industries, Inc., Clackamas, OR (US)

(72) Inventors: Bryan Averill, Portland, OR (US); Darren Fretz, Oregon City, OR (US); Kevin Talmadge, Portland, OR (US); Ian Wendler, Portland, OR (US)

(21) Appl. No.: 14/847,890

(22) Filed: Sep. 8, 2015

Related U.S. Application Data
(60) Provisional application No. 62/060,393, filed on Oct. 6, 2014.

(51) Int. Cl. G06F 3/02; G06F 3/0482; G06F 3/01; B66D 1/46; G06F 1/16

(52) U.S. Cl. CPC G06F 3/0202; B66D 1/46; G06F 1/1684; G06F 1/1637; G06F 3/016; G06F 3/0482

(57) ABSTRACT

Methods and systems are provided for adjusting operation of multiple accessories of a vehicle using a single control user interface in communication with a single modular accessory controller of the vehicle. In one example, a system may include a modular accessory controller for a vehicle electrically coupled to a battery and two or more accessories of the vehicle and a control interface in communication with the modular accessory controller and including a plurality of buttons for providing user input for operating each of the two or more accessories of the vehicle.

### FIELD

The present application relates generally to a user interface for a powersports vehicle.

### SUMMARY/BACKGROUND

Vehicles, such as powersports vehicles, are often equipped with auxiliary systems (e.g., accessories) such as winches, plows, compressors, and lights. These accessories may be controlled by various switches positioned on the vehicle and/or a wired or wireless remote. In one example, a handlebar switch may operate the winch from a riding position. However, handlebar switches may transmit a relatively high current, thereby resulting in a bulky switch component. Other powersports vehicles may include a dashboard switch and/or a wired or wireless remote. However, an additional switch may be required for each device (e.g., accessory) and/or each control function of each device. Additionally, a vehicle operator may be required to manually adjust certain winch operations at the winch, thereby increasing the time and effort required in winch operation. As such, different winch and/or accessory functions may be accessible from different positions in the vehicle, and some may only be accessed from outside of the vehicle. This results in increased time and effort of adjusting different accessory operations during powersports vehicle use.

In one example, the above issues may be at least partially addressed by a system including a modular accessory controller for a vehicle electrically coupled to a battery and two or more accessories of the vehicle and a control interface in communication with the modular accessory controller and including a plurality of buttons for providing user input for operating each of the two or more accessories of the vehicle. In this way, a single control interface may control operation of multiple vehicle accessories via a modular accessory controller of the vehicle, thereby the ease and efficiency of adjusting multiple accessory operations during vehicle use.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of a configuration for a control system of a powersports vehicle.

FIG. 2 shows a flow chart of a method for controlling various accessories of a powersports vehicle using a user control interface.

FIG. 3 shows a schematic diagram of example user interface displays of a user control interface of a powersports vehicle.

FIG. 4 shows a diagram of a modular accessory control unit for a powersports vehicle.

FIG. 5 shows an example dashboard mount for a removable button pad of a user control interface for a powersports vehicle.

FIG. 6A shows a perspective view of an example handlebar mount for a removable button pad of a user control interface for a powersports vehicle.

FIG. 6B shows a side view of the example handlebar mount of FIG. 6A.

FIG. 6C shows an exploded view of the example handlebar mount of FIGS. 6A-6B with the button pad detached from the mount.

FIG. 7 shows an example shifter mount for the removable button pad of FIGS. 6A-6C of a user control interface for a powersports vehicle.

FIG. 8 shows an example roll bar mount for the removable button pad of FIGS. 6A-6C of a user control interface for a powersports vehicle.

FIG. 9 shows an example wrist mount for the removable button pad of FIGS. 6A-6C of a user control interface for a powersports vehicle.

FIG. 10 shows a schematic of a first embodiment of a control interface for a powersports vehicle.

FIG. 11 shows a schematic of a second embodiment of a control interface for a powersports vehicle.

### DETAILED DESCRIPTION

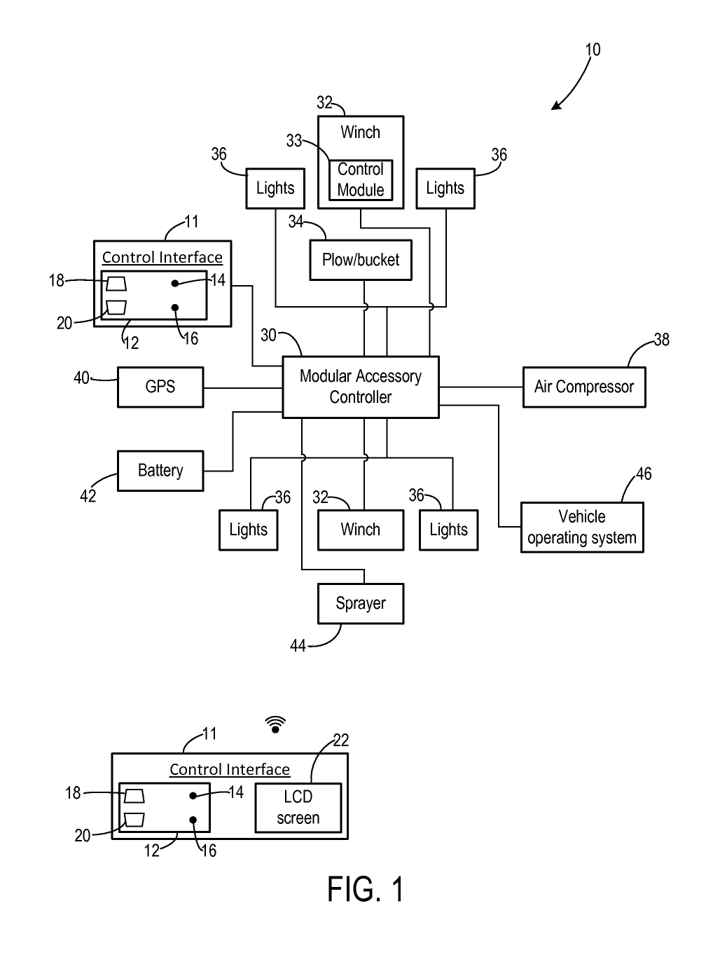

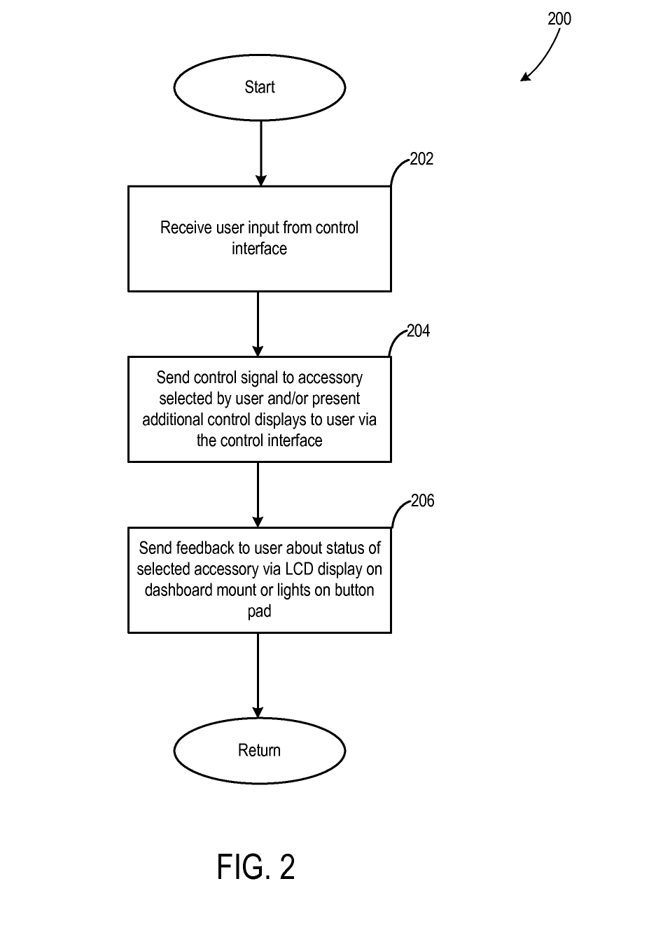

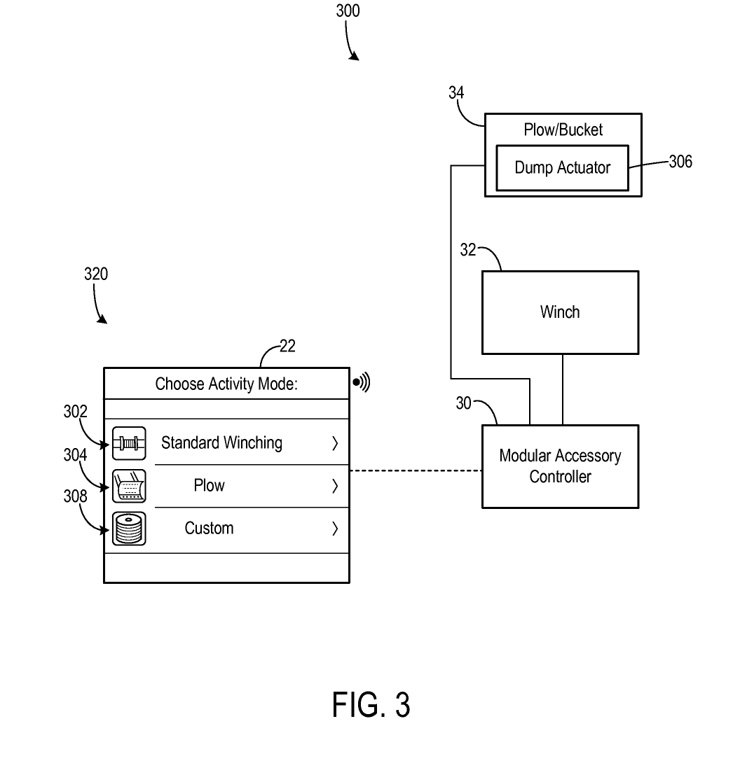

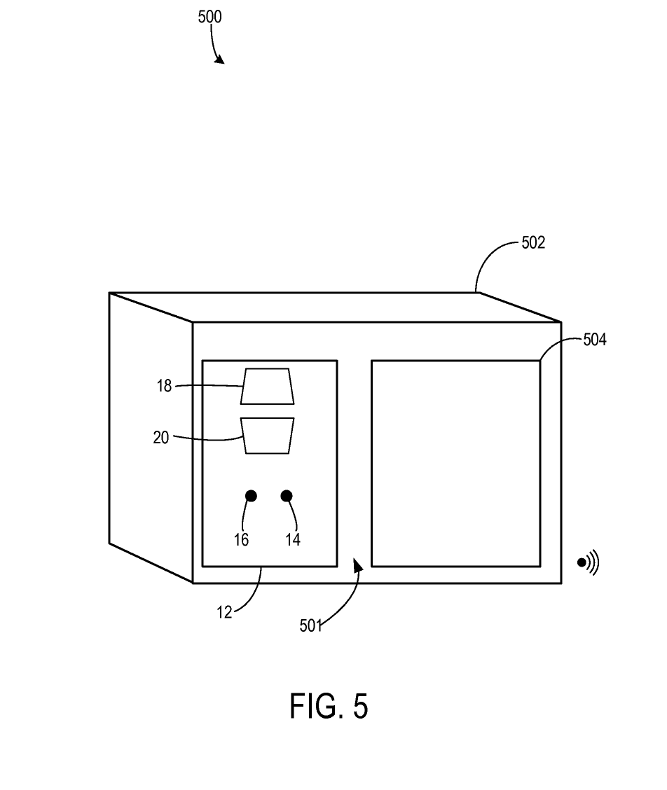

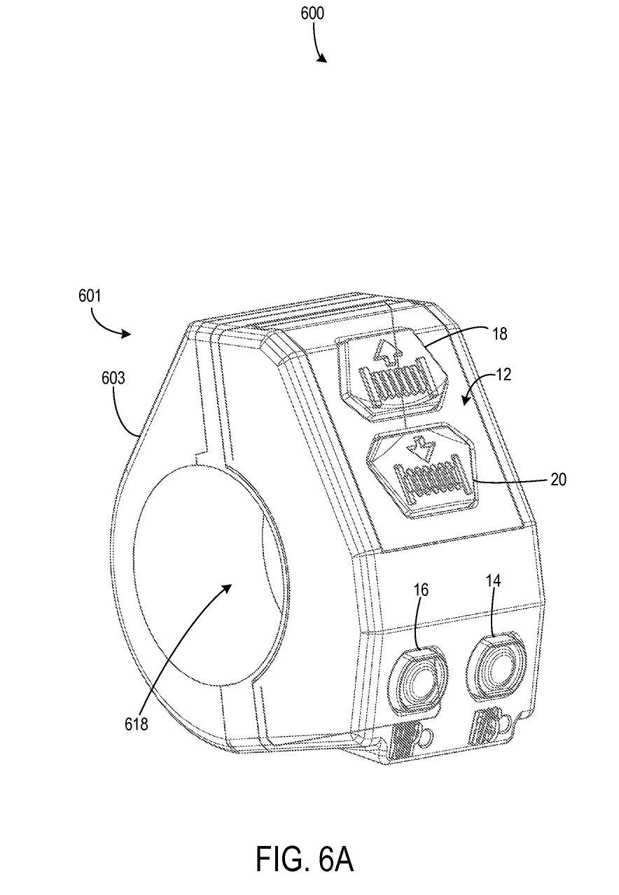

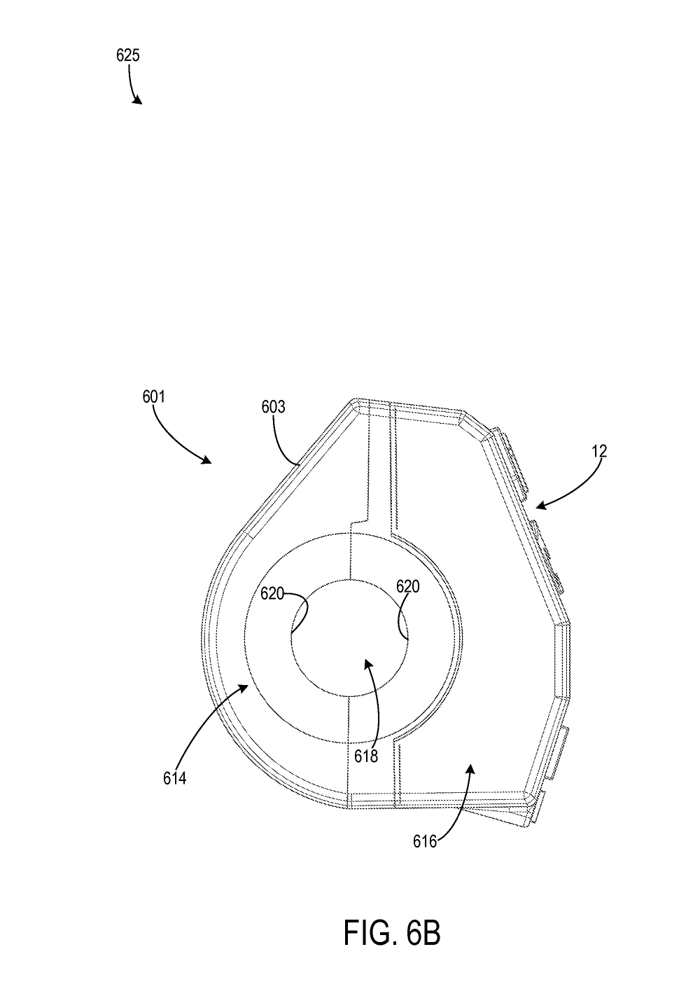

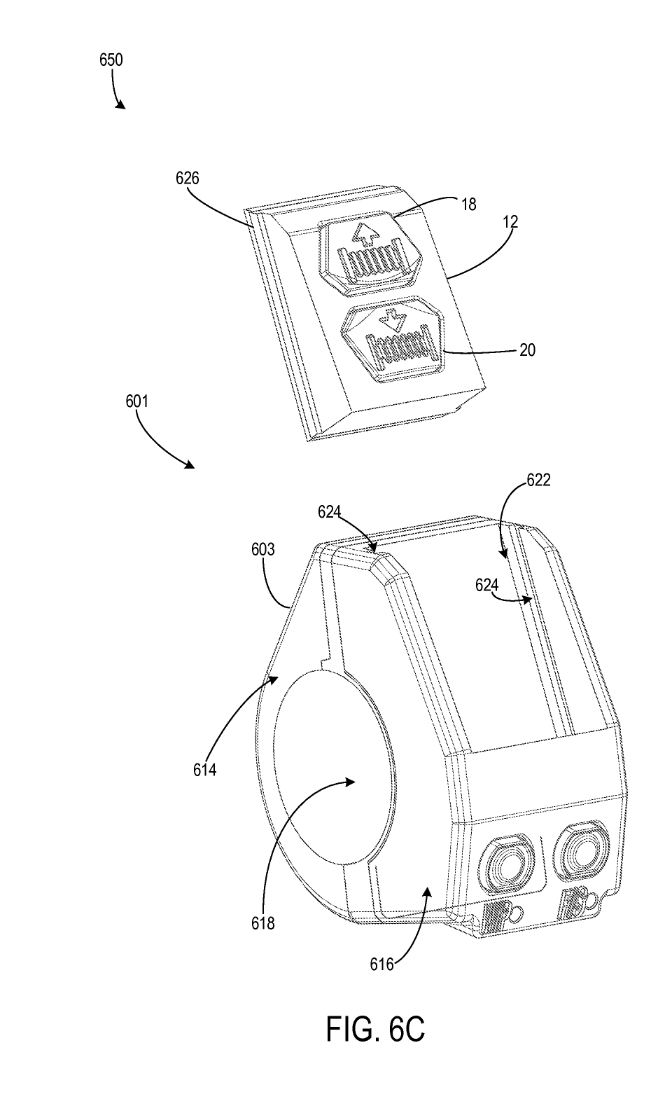

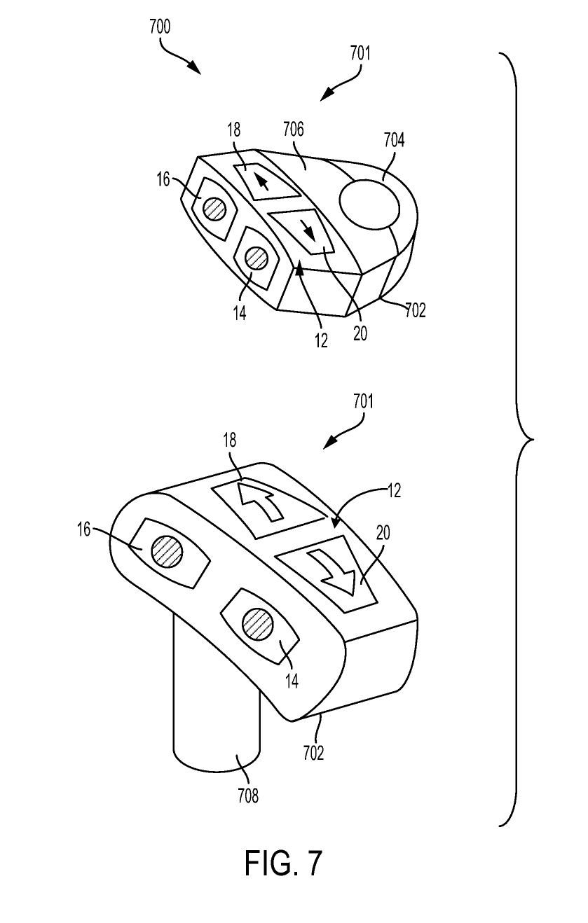

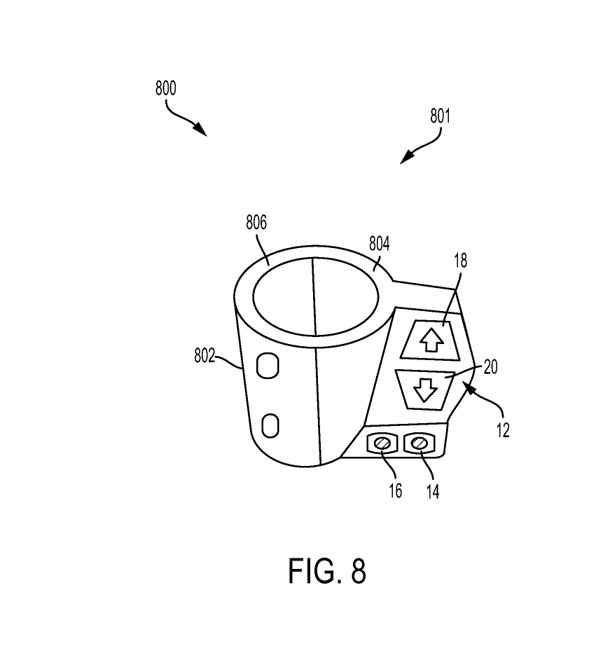

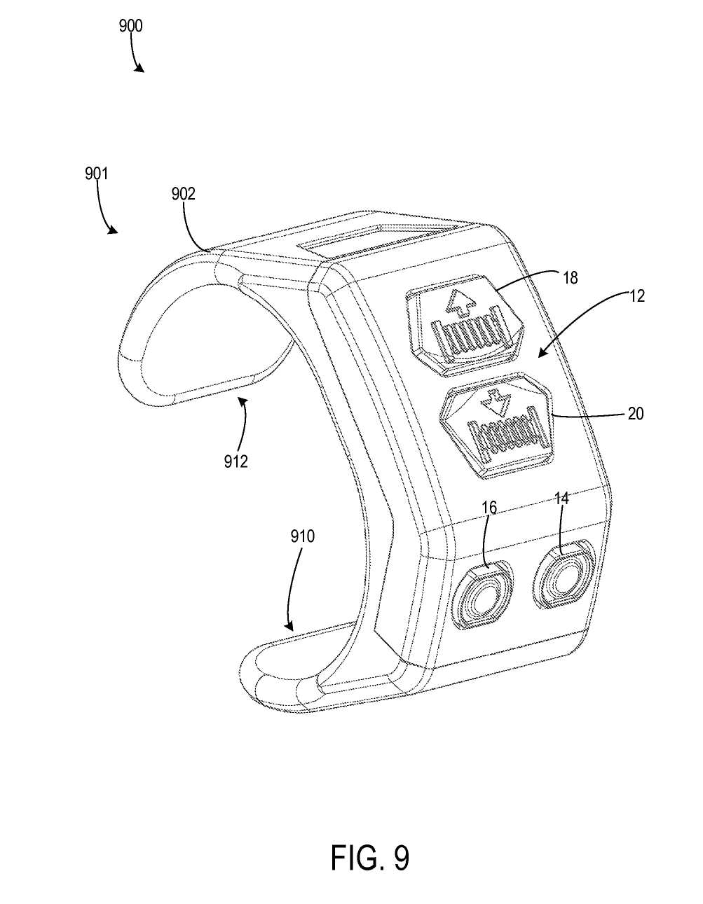

The following detailed description relates to systems and methods for adjusting operation of multiple accessories of a powersports vehicle using a control user interface in communication with a modular accessory controller of the vehicle, such as the modular accessory controller shown in FIGS. 1, 3, and 4. In one example, the control user interface may include a removable button pad that may be attached to a variety of different user interface mounts (both wired and wireless). The user interface mounts may be positioned at different locations on or around the powersports vehicle. These different locations may allow a user to comfortably adjust operation of multiple vehicle accessories from a single, riding position in the vehicle. Examples of different user interface mount locations are shown in FIGS. 5-9. For example, user interface mounts may be placed on a vehicle dashboard as shown in FIG. 5, a vehicle handle bar as shown in FIGS. 6A-6C, a vehicle shifter as shown in FIG. 7, and/or on a vehicle roll bar as shown in FIG. 8. A user interface may additionally or alternatively be worn by the user on their wrist, as shown in FIG. 9. The user interface mounts may be wired or wirelessly connected to the modular accessory controller, the modular accessory controller attached to the vehicle to carry out the commands received from the control user interface. The control user interface may include the button pad and an LCD screen which may be used to provide the user with an interactive display allowing for more intuitive control of vehicle accessories. Possible display configurations are shown in FIG. 3. A method for controlling the various accessories using the modular accessory controller is shown in FIG. 2.

FIG. 1 shows a schematic 10 of a control system for operating various accessories (e.g., devices) of a vehicle. In one embodiment, the vehicle may be a powersports vehicle such as an ATV or UTV. The system includes a modular accessory controller 30 attached to the vehicle that may receive input from a user through a wired or wirelessly connected control interface 11. Said another way, the modular accessory controller 30 is both physically and electrically coupled to the vehicle. For example, the modular accessory controller 30 may be electrically coupled to a vehicle controller, such as a vehicle operating system 46, as shown in FIG. 1. The control interface (e.g., control user interface) may be electrically coupled to the modular accessory controller 30 through either a two-way wireless connection or a wired electrical connection.

The modular accessory controller 30 may be powered by a battery 42. In one example, the battery 42 may be a battery of the vehicle. The modular accessory controller 30 may also be electrically coupled to a plurality of accessories (e.g., devices) including, but not limited to, a winch 32, plow/bucket 34, one or more lights 36, global positioning system (GPS) 40, air compressor 38, and sprayer 44. In one example, the modular accessory controller 30 may be electrically coupled to at least two accessories. For example, the modular accessory controller 30 may be electrically coupled with the winch 32 and the plow/bucket 34. Specifically, the modular accessory controller 30 may be electrically coupled to a winch controller, such as winch control module 33 of the winch 32. Thus, the winch control module 33, may be a control module or controller of the winch 32 configured to execute various winching operations in response to signals received from the modular accessory controller 30. In another example, the modular accessory controller 30 may be coupled with one or more lights 36 and air compressor 38. In yet another example, the modular accessory controller 30 may be electrically coupled to three or more accessories which may or may not include the winch 32. Thus, in some examples, the modular accessory controller 30 may be in electrical communication with a vehicle controller (e.g., vehicle operating system 46) and a winch controller (e.g., winch control module 33) of a winch coupled to the vehicle. However, in other examples, the modular accessory controller 30 may be in electrical communication with only the winch control module 33 or the vehicle operating system 46.

The control interface 11 includes a button pad 12 including a plurality of buttons. The button pad 12 may be removably coupled to a mount (e.g., interface mount). As such, the control interface 11 may be electrically coupled to the mount (not shown in FIG. 1), which is in turn electrically coupled to the modular accessory controller 30. In alternate embodiments, the mount may be included as part of the control interface 11. It should be noted that one vehicle may include multiple mounts (both on and off the vehicle) adapted to electrically couple with the same control interface 11, as described further below with reference to FIGS. 5-9.

The button pad 12 may include a first control button 18 and a second control button 20. In one example, the first control button 18 and the second control button 20 may be up-down control buttons that appear as an upward facing arrow (first control button 18) positioned above a downward facing arrow (second control button 20) that allow the user to power-in or power-out the winch and also toggle through menu options displayed on a LCD screen (e.g., display screen) 22 of the control interface 11. In alternate embodiments, the first control button 18 and the second control button 20 may not include the upward and downward facing arrows. For example, a different icon (or no icon) may be displayed on these buttons. However, the first and second control buttons 18 and 20 may still control the winch power-in and power-out functions. In one example, the LCD screen 22 is part of the control interface 11. Specifically, the LCD screen 22 may in some examples be removably and mechanically coupled to the control interface 11. However, in other examples, the LCD screen 22 may be integrally formed as part of the control interface 11. In another example, the control interface 11 may not include the LCD screen 22 and instead the LCD screen 22 may be remotely located but electrically coupled with the control interface 11.

Further, the button pad 12 may include a free spool clutch control button 14 that allows the user to engage and disengage a clutch of the winch. For example, when the clutch of the winch is disengaged, rope from the winch may be let out without power from a motor of the winch. The button pad 12 may also include an activity mode selection button 16 that allows the user to select an accessory for use and/or an activity mode of the winch 32.

The button pad 12 may include alternative or additional buttons to those described above. For example, the button pad 12 may include a single select button for selecting various options displayed via LCD screen 22. The single select button may also send signals to the modular accessory controller 30 to turn on and off lights or other accessories, for example, once a specific accessory for control has been chosen. As such, a single button may control multiple accessories (e.g., control operation of at least two accessories). The first and second control buttons 18 and 20 may toggle through the different menu selections displayed via the LCD screen 22. In another embodiment, the button pad 12 may include dedicated buttons for operating each accessory coupled to the vehicle and the modular accessory controller 30.

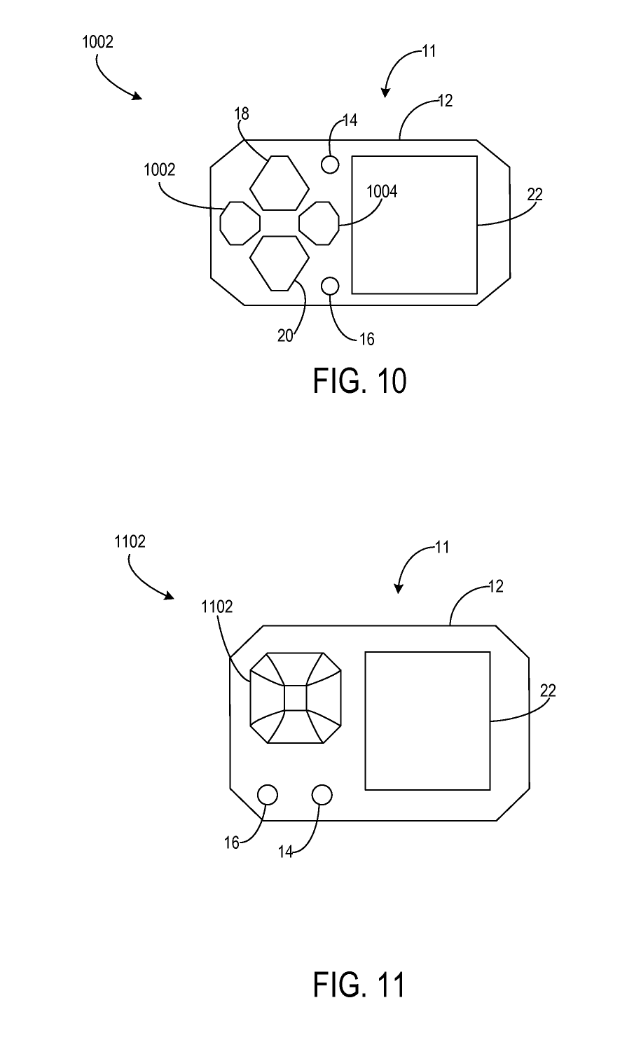

For example, FIGS. 10 and 11 show alternate embodiments of the control interface 11 and button pad 12 that may be used as any of the control interfaces described herein. As shown in FIG. 10, the button pad 12 may include the first control button 18, second control button 20, free spool clutch control button 14, and activity mode selection button 16. Additionally, the control interface 11 includes LCD screen 22. The button pad 12 may further include a first pivot button 1002 and second pivot button 1004 that control a plow/bucket coupled to the powersports vehicle. For example, the first and second pivot buttons 1002 and 1004 may pivot (e.g., rotate) the plow or bucket coupled to the vehicle. As shown in FIG. 11, the button pad 12 may include the free spool clutch control button 14, activity mode selection button 16, and a multi-way button 1102. The multi-way button 1102 may be a 4 or 5 way thumb switch allowing a user to adjust multiple winch and vehicle accessory functions (e.g., 4 or 5 functions) with only a single button. For example, each portion (or section) of the multi-way button 1102 may send a different activation signal to the modular accessory controller 30. In one example, the multi-way function may control operation of the winch (e.g., power-in and power-out functions) and/or operation of a plow/bucket (e.g., pivot). The multi-way button 1102 may also include a select portion for selecting items on the LCD display 22 or may be programmed to control an additional actuator.

In other examples, the button pad 12 may further include a plurality of micro current switches coupled to one or more of the buttons 14, 16, 18, 20, 1102, and 1104 to increase ease of use of said buttons for a user.

All inputs from the button pad 12 are received by the modular accessory controller 30, which functions as a central processing unit. In addition to carrying out the commands from user input, the modular accessory controller 30 may also provide the user with feedback via the LCD screen 22, as described in greater detail below with reference to FIG. 5.

FIG. 2 shows a flow chart of a method 200 for adjusting operation of various accessories coupled to a powersports vehicle using a user control interface. Instructions for carrying out method 200 may be stored in a memory of a controller, such as modular accessory controller 30 shown in FIG. 1. As such, the modular accessory controller may execute method 200 as described below.

Method 200 begins at step 202 by receiving one or more user inputs, at the modular accessory controller, from a control interface (such as control interface 11 shown in FIG. 1). The one or more user inputs may include inputs for adjusting operation of one or more accessories coupled to a vehicle, such as a powersports vehicle (e.g., sport utility vehicle). As described above, the one or more accessories may include one or more of a winch, lights, a sprayer (or spreader), a plow (or bucket), an air compressor, or the like. In one embodiment, method 200 may include, before step 202, presenting a menu display to a user via a display screen (e.g., LCD screen 22) of the control interface. As such, the user may select from a plurality of menu options, such as selecting which accessory the user wishes to adjust from the control interface. For example, if the user selects to adjust operation of a winch coupled to the vehicle, the user may then select from one or more winch modes via a winch activity mode selection button (e.g., activity mode selection button 16 shown in FIG. 1). The modular accessory controller may receive both the accessory mode and the activity mode input (for the selected input) at 202.

Following step 202, at step 204, the modular accessory controller may send a control signal to the selected accessory based on the received user input. Specifically, the method 200 at step 204 may comprise sending an electrical signal to an actuator of one or more of the accessories selected by the user, to adjust the position and/or operation of the one or more accessories. For example, as shown in FIG. 3, the modular accessory controller may be in electrical communication with a dump actuator of a plow/bucket. In response to signals received from the user via the control interface to adjust the pivot angle of the plow/bucket, the modular accessory controller may correspondingly send signals to the dump actuator for pivoting the plow/bucket. In this way, the method at 204 may comprise adjusting operation of the one or more accessories based on inputs received from the user via the control interface.

The control signals sent to the one or more accessories at 204 may include one or more of powering on or off the selected accessory, adjusting operating of the selected accessory, and/or modulating current and/or voltage supplied to the selected accessory. In this way, a single control interface and single modular accessory controller of the vehicle may adjust operation of two or more accessories coupled to the vehicle. In some embodiments, the single modular accessory controller may adjust operation of all the aftermarket accessories coupled to the vehicle.

The method at 204 may additionally or alternatively include presenting additional control displays to the user via a user interface of the control interface (e.g., via the LCD screen 22 of the control interface 11 shown in FIG. 1) based on the user inputs received at 202. As an example, in response to a user request for a “custom mode,” the method at 204 may comprise sending a signal from the modular accessory controller to the control interface to present the user with various custom load amounts. In response to the user selection of a particular load amount, the modular accessory controller may send signals to an actuator of the user desired accessory for adjusting the position and/or function of the accessory based on the load amount input by the user.

Following sending control signals to the various accessories at 204, the method proceeds to 206 to send feedback to the user about the status of the selected accessory via the LCD display screen and/or via lights on the button pad of the control interface. For example, if the modular accessory controller sends a signal to activate (e.g., turn on) a light or plow, the controller may then send a signal to the control interface following activation of the light or plow to indicate that the light or plow has been activated. In this way, the current operating status of the one or more accessories selected by the user, may be communicated and presented to the user via the LDC display and/or via lights on the button pad of the control interface. An example user interface that may be presented to a user on the LDC display is shown below with reference to FIG. 3.

Turning to FIG. 3, a schematic 300 of a user interface 320 of the control interface (e.g., control interface 11 shown in FIG. 1) is described. In one example, the user interface 320 may be displayed via an LCD screen 22 of the control interface. As such, the user interface 320 may be a graphic user interface displaying a variety of menu and/or control displays to a user for adjusting operation of one or more vehicle accessories electrically coupled to the modular accessory controller 30. However, it should be appreciated that in alternate embodiments, the user interface 320 may be displayed via a display screen other than an LCD screen, such as LED, laser, holographic, etc. As described above with reference to FIG. 1, the one or more accessories coupled to the modular accessory controller 30 may include a winch 32 and/or a plow/bucket 34. The schematic 300 shows different possible displays that may be displayed via the LCD screen 22.

As described above, a user may use the control interface to adjust the operation of one or more accessories coupled to the modular accessory controller 30. For example, the user may use the control interface to adjust operation of the winch 32. However, the winch 32 may be used for different activities or applications, including a winching operation, a plowing operation (e.g., lifting a plow or bucket), or another custom operational mode. In one example, the user interface 320 may display to a user (via the LCD screen 22) several different winch activities or modes. Specifically, the modular accessory controller may send signals to the LCD screen 22 to display several different winch activities or modes to the user in response to a user request to operate the winch. Thus, the example display shown on the LCD screen 22 in FIG. 3, may be a display presented to the user after a user selection of the winch accessory.

The different winch activities may be displayed via a winch activity mode display. For example, the user may select a standard winching mode 302, a plow mode 304, and/or a custom mode 308. A user may select one or more of the activity modes via either a wired or wireless connection with a button pad (e.g., button pad 12 shown in FIG. 1). Thus, the modular accessory controller 30 may receive the activity modes selections (e.g., user inputs) via the button pad (e.g., button pad 12 shown in FIG. 1). However, in other examples, the LCD display 22 may be a touch display, and the activity mode selections may be input by the user via the LCD display 22. The modular accessory controller 30 may then adjust the voltage and/or current supplied to the winch 32 and/or dump actuator 306 though respective electrical connections based on the stored operational voltage and/or current ranges and data corresponding to each activity mode.

The custom mode 308 may allow a user to adjust a load amount or a load limit of the winch 32. The plow mode 304 may allow the user to operate the plow/bucket 34 coupled to the winch. Specifically, the plow mode 304 may be used to adjust a pivot angle of the plow/bucket 34. Thus, in response to the user selection of the plow mode 304, the modular accessory controller 30 may send signals to dump actuator 306 to adjust the pivot angle of the plot/bucket 34. Based on signals received from the modular accessory controller 30, the dump actuator, which may be any suitable electromechanical actuator, may mechanically rotate the plow/bucket. An amount of electrical power provided to the dump actuator 306 may be adjusted based on input from the user.

In other examples, the winching mode 302 may be used to adjust the height of the plow/bucket 34. As such, the winch 32 may be mechanically coupled to the plow/bucket 34 for adjusting the position thereof, based on signals received from the modular accessory controller 30. Thus, the user may have control over the height of the plow bucket 34 through manipulation of the power supplied to the winch 32 and the angle of the plow bucket 34 through manipulation of the winch 32 and/or dump actuator 306. Further, during operation of the winch 32 and/or dump actuator 306, the modular accessory controller 30 may provide the user with feedback on the current status (e.g., load, power output, current draw, speed, etc.) of the winch 32 and/or dump actuator 306 via the LCD screen 22.

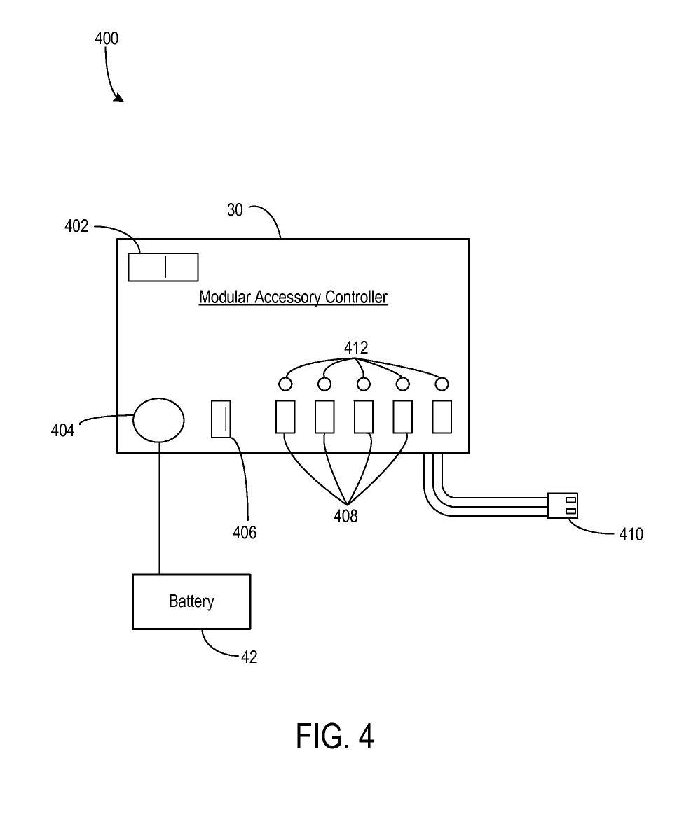

In this way, a user may choose to operate one or more accessories. After selecting an accessory for use, the user may be prompted by a display screen provided on an LCD display, to choose an operating mode for the selected accessory. The user may select an accessory for use and adjust operation of the selected accessory via an input device such as button pad, touch screen, etc. Further, during operation of the one or more accessories, the user may be provided with feedback on the current status (e.g., load, power output, current draw, speed, etc.) of the one or more accessories via the display screen. As such, a user may continuously monitor and adjust operation of the one or more accessories. An example configuration of the modular accessory controller is shown below with reference to FIG. 4.

FIG. 4 shows a schematic 400 of an embodiment of a configuration of modular accessory controller 30 described above with reference to FIGS. 1 and 3. In one example, the modular accessory controller 30 may be powered by a dedicated battery 42 electrically connected to a corresponding outlet 404. For example, the battery 42 may be a 12V battery. In another example, the battery 42 may be a battery of the vehicle (e.g., powersports vehicle). The modular accessory controller 30 may be turned on or off via an ON/OFF switch 402. In addition, the modular accessory controller 30 may have several accessory inputs 408. For example, the accessory inputs 408 may include inputs from a GPS, lights, or another type of accessory. LED pairing indicators 412 may indicate when an accessory device is successfully paired with the modular accessory controller 30. A USB outlet 406 equipped on the modular accessory controller 30 may be used to connect other accessories, such as phones and ipods to the modular accessory controller 30. Finally, the modular accessory controller 30 may utilize hi amp electrical cables (e.g., outputs) 410 to power and electrically couple to accessories such as a winch, plow, sprayer, etc.

FIGS. 5-9 show example mounts for a removable button pad (e.g., button pad 12 shown in FIG. 1) of a user control interface (e.g., control interface 11) for a powersports vehicle. The user control interfaces of FIGS. 5-9 may include similar components to those of control interface 11 shown in FIG. 1. As such, similar components may be numbered similarly and function as described above with reference to FIG. 1. Each of the user control interfaces of FIGS. 5-9 may include a removable button pad 12, a mount for mounting the removable button pad 12 to the vehicle or a user, and optionally an LCD screen for presenting feedback and/or control menu options to a user (e.g., may be similar to LCD screen 22 shown in FIG. 1). The same removable button pad 12 may be used on and attached to all the interface mounts shown in FIGS. 5-9. As such, the button pad 12 may be interchangeable between a plurality of mounts at different locations on or around the vehicle and/or user. Thus, each of the interface mounts shown in FIGS. 5-9 may have similar electrical connections that couple and mate with (via face-sharing contact) corresponding electrical connections of the button pad 12. As such, the button pad 12 is electrically coupled to each interface mount and each interface mount is then electrically coupled (either wirelessly or through a wired connection) to the modular accessory controller 30, shown above in FIGS. 1, and 3-4, in order to send control signals to the modular accessory controller to adjust operation of a plurality of vehicle accessories.

FIG. 5 shows a diagram 500 of a user control interface 501 adapted to be mounted to a dashboard of a powersports vehicle (or a vehicle in which the modular accessory controller is included). Control interface 501 may be the same or similar to the control interface 11 shown above in FIG. 1. The user control interface 501 includes an interface mount 502 to which a button pad 12 may be mounted. In one embodiment, the interface mount 502 may be fixed onto the vehicle. In another embodiment, the interface mount 502 may be removable from and mechanically fitted to the dashboard via mating splines or alternate mating parts. The interface mount 502 may be hard wired to the vehicle and draw power from the vehicle, or it may have its own battery. The user control interface 501 may communicate with the modular accessory controller 30 via a wired connection between the interface mount 502 and the modular accessory controller 30. However, it is also possible for the connection between the controller 30 (discussed above with reference to FIGS. 1, and 3-4) and the user control interface 501 to be wireless (e.g., a two-way wireless connection). The interface mount 502 (also referred to as a dashboard mount) may contain an LCD screen 504. LCD screen 504 may be the same or similar to LCD screen 22 shown above in FIG. 1. As such, the LCD screen 504 may in some examples be removably and mechanically coupled to the interface mount 502. However, in other examples, the LCD screen 22 may be integrally formed as part of the interface mount 502. In another example, the interface mount 502 may not include the LCD screen 504, and instead the LCD screen 504 may be remotely located but electrically coupled with the control interface 501. Said another way, the LCD screen 504 may be mounted to a vehicle, remote from the interface mount 502, but may be electrically coupled with the interface mount 502.

As described above, the button pad 12 may be removable from the interface mount 502. In alternate embodiments, the LCD screen 504 may also be removable from the interface mount 502. For example, the removable button pad 12 may be detached and reattached to the interface mount 502 via a quick attachment system that consists of mating parts such as snapping flanges or an alternate mechanical coupling mechanism. As described earlier in FIG. 1, the button pad 12 contains first and second control buttons 18 and 20 that may allow the user to modulate whether the winch is powering in or out during winch operation. The first and second control buttons 18 and 20 may additionally or alternatively be used to toggle through menu options presented at the LCD display screen 504, as described earlier in FIG. 3. A freespool clutch control button 14 and an activity mode selection button 16 may also be located beneath the first and second control buttons 18 and 20.

User input may be displayed on the LCD screen 504 and may allow the user to see what accessories they may operate via the user control interface 501. A user may then select particular functions for a selected accessory. The LCD screen 504 may also provide the user with feedback on the status of the accessory during use of the accessory, where the feedback may include but is not limited to: the voltage and/or current being supplied to said accessory, temperature of the motor of said accessory, etc. Together, the button pad 12, the LCD screen 504, and the interface mount 502 make up a user control interface 501 that allows the user interactive control of multiple accessories on a powersports vehicle. It should be noted, in some embodiments, the user control interface 501 may not include the LCD screen 504 and may instead present the user with feedback with a plurality of LED lights and/or tactile feedback via the buttons of the button pad 12.

Another mount to which the movable button pad 12 may be attached to is shown in FIGS. 6A-C. Specifically, diagrams in FIGS. 6A-6C show a user control interface 601 that may be attached to a handle bar of a powersports vehicle to allow the user a convenient location for controlling vehicle accessories.

Turning now to FIG. 6A, it shows a perspective view 600 of the control interface 601. User control interface 601 may be the same or similar to the control interface 11 shown above with reference to FIG. 1. The user control interface 601 may include the button pad 12 removably coupled to an interface mount 603. The interface mount 603 may be a ring-shaped mount with a hollow center 618 that fits over a handle bar of the vehicle. The interface mount 603 may be electrically coupled to the modular accessory controller 30 (discussed above with reference to FIGS. 1, and 3-4) via a wire and may draw power from the vehicle battery. However, in other examples, the interface mount 603 may be wirelessly coupled to the modular accessory controller 30 and may include its own battery or other power source. The button pad 12 may be detached and reattached to the interface mount 603 (e.g., handle bar mount) via a quick attachment system as described earlier in FIG. 5. The button pad 12 is shown detached from the mount 603 in FIG. 6C. As described above, the button pad 12 shown in FIGS. 6A-6C may be the same button pad shown in FIGS. 1 and 5 and thus include the same buttons as described above.

FIG. 6B shows a side view 625 of the control interface 601. Components of the control interface 601 already introduced in FIG. 6A may not be reintroduced or described again in the description of FIGS. 6B-6C. As illustrated in FIG. 6B, the interface mount 603 may include the hollow center 618 that fits over a handle bar of a powersports vehicle. More specifically, the mount 603 may include two structural components that may be detached and reattached to fit around a handle bar. For example, the mount 603 may include a first structural element 616 and a second structural element 614, which together may comprise the mount 603. The first structural element 616 and second structural element 614 may be removably coupled so that the mount 603 may be fitted around the handle bar of the vehicle. Each of the structural elements 614 and 616 may be shaped to include semi annular recesses 620, which form the hollow center 618. As shown in FIG. 6B, the first and second structural elements, 616 and 614 respectively, may be physically coupled to one another so that their semi annular recesses 620 form the hollow center 618, which may receive the handle bar. Said another way, the mount 603 may be fitted on the handle bar, so that the handle bar substantially fills the hollow center 618, and is in face sharing contact with the semi annular recesses 620. Thus, the handle bar mount 603 may fully enclose a circumference of the handle bar.

Turning now to FIG. 6C, it shows an exploded view 650 of the control interface 601, with the button pad 12 detached from the mount 603. As shown in FIG. 6C, the mount 603 may include a slot 622 for receiving and housing the button pad 12. Thus, the button pad 12 may be inserted or removed from the slot 622 of the mount 603. Specifically, the slot 622 may include grooves 624, which may be configured to receive mating flanges 626 of the button pad 12. Said another way, the button pad 12 and mount 603 may be physically coupled to one another via mating flanges 626 of the button pad 12, and grooves 624 of the mount 603. However, in other examples, other attachment methods such as magnets, snapping flanges, Velcro, etc., may be used to removably couple the button pad 12 to the mount 603.

FIG. 7 shows a diagram 700 of a user control interface 701 mountable to a shifter of a powersports vehicle. The user control interface 701 includes the button pad 12 and an interface mount 702. The button pad 12 may be removably coupled to the interface mount 702 and the interface mount 702 may be coupled to a shifter of the powersports vehicle. The interface mount 702 may include of a knob 706 to which the removable button pad 12, as described earlier in FIG. 1, could be easily detached and reattached to using a quick attachment system, as described earlier in FIG. 5. A semicircular piece 704 may fit around the shifter and lock with the knob 706 using a mechanical mating system such as splines or snapping flanges. The mating of semicircular piece 704 and knob 706 may secure the user control interface 701 to the shifter. The interface mount 702 may additionally or alternatively include a replacement shifter knob 708 that may replace the existing vehicle shifter. The interface mount 702 may, in one embodiment, be electrically coupled to the modular accessory controller 30 (discussed above with reference to FIGS. 1, and 3-4) and draw power from the vehicle. Alternately, in another embodiment, the interface mount 702 may have its own power source and be wirelessly connected to the modular accessory controller 30.

FIG. 8 shows a diagram 800 of yet another user control interface 801 that may be attached to a roll bar of a powersports vehicle. The user control interface 801 includes the button pad 12 and an interface mount 802, the button pad 12 removably coupled to the interface mount 802 and the interface mount 802 in turn coupled to a roll bar of the powersports vehicle. The interface mount 802 consists of two mechanically mating parts 804 and 806 that snap around the roll bar to secure the user control interface 801 to the roll bar. The removable button pad 12 from FIG. 1 can be detached or reattached to the interface mount 802 using a quick attachment system as described in FIG. 5. The interface mount 802 may be wired or wirelessly connected to the modular accessory controller 30 from FIGS. 1, and 3-4, and may be electrically coupled to the vehicle battery or it may have its own battery.

Turning now to FIG. 9, a perspective view 900 is shown depicting a user control interface 901 that may be worn on a user's wrist is shown. The user control interface 901 includes the button pad 12 and an interface mount 902, the button pad 12 removably coupled to the interface mount 902, the interface mount 902 in turn coupled to a wrist of a powersports vehicle user. As such, the interface mount 902, may be referred to herein as wrist mount 902. The interface mount 902 may include two ends, a first end 910 and a second end 912. Further, the interface mount 902 may be constructed from a flexible material such as rubber. Thus, in some examples, the first end 910 and second end 912 may not be physically coupled to one another, and the mount 902 may fit over a majority of the circumference of a user's wrist, so that the mount 902 is secured to the user's wrist. Thus, the elasticity of the mount 902, may be configured to adapt to a variety of wrist sizes of a user.

However, in other examples, the first end 910 and second end 912 may be removably coupled to one another, so that the mount 902 may fit around a circumference of the user's wrist. The first and second ends 910 and 912 respectively, may be coupled to one another using any viable detachable and re-attachable mechanical linkage such as Velcro, magnets, straps, locking pin, etc. As described above with reference to FIG. 5, the interface mount 902 may have a quick attachment system (as well as an electrical connection) that allows the button pad 12 to be electrically coupled and detached and reattached to the interface mount 902. The interface mounts 902 may be wirelessly connected to the modular accessory controller 30 (shown above in FIGS. 1, and 3-4) and may have its own battery for a power source.

In this way, a single user control interface communicating with a modular accessory controller of a vehicle may allow a user to control multiple vehicle accessories from convenient locations both on and off a vehicle (e.g., a powersports vehicle). The user control interface also provides a more intuitive and interactive user experience by way of feedback presented on an optional LCD display or another feedback mechanism. The modular accessory controller on the vehicle distributes power to various vehicle accessories based on user input via a removable button pad of the user control interface. The button pad may be removably and interchangeably mounted to various interface mounts either wired or wirelessly connected to the modular accessory controller. This may allow a user to choose the most convenient location to operate vehicle accessories such as the dashboard or handle bar of the vehicle, or even the wrist of the user. Further, due to compatible and similar electrical and mechanical mating connections, the same button pad may be moved to different interface mounts positioned on or around the same vehicle. Thus, the user may control a subset of or all vehicle operations from one position, without having to change or shift positions to reach different control buttons corresponding to different vehicle accessories. As such, a technical effect of increasing accessibility to a control interface of a vehicle is achieved by providing a system including a removable and interchangeable control interface in communication with a modular accessory controller of a vehicle to adjust operation of two or more accessories coupled to the vehicle (and the modular accessory controller) from only one device and from a single riding position in the vehicle. Said another way, by including a removable button pad which may be attached to any one or more of a plurality of mounts, the mounts located at convenient locations throughout the vehicle, a user may more easily control operation of vehicle accessories from a single riding position in the vehicle. This may also increase the safety of the user as the user may not be required to leave the vehicle to adjust accessory operation (e.g., such as winch operation).

In another representation, a vehicle comprises a vehicle controller; a winch including a winch controller adapted to adjust operation of the winch; a first accessory coupled to the vehicle; and a modular accessory controller adapted to communicate with the vehicle controller and winch controller, and adjust operation of the winch and first accessory based on inputs received at a removable control interface, the removable control interface adapted to be coupled to a plurality of interchangeable mounts positioned at different locations around the vehicle.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system, comprising:
a modular accessory controller for a vehicle electrically coupled to a battery and two or more accessories of the vehicle; and
a control interface in communication with the modular accessory controller and including a plurality of buttons for providing user input for operating each of the two or more accessories of the vehicle.

2. The system of claim 1, wherein the control interface includes a removable button pad and a mount, the removable button pad removable from the mount and the mount in communication with the modular accessory controller, wherein the removable button pad includes the plurality of buttons.

3. The system of claim 2, wherein the removable button pad includes a first mating interface including a first electrical connection and a first mechanical connection and wherein the mount includes a second mating interface including a second electrical connection and a second mechanical connection, the first mating interface mating with the second mating interface to both electrically and mechanically coupled the removable button pad and mount to one another.

4. The system of claim 2, wherein the mount is positioned at one or more of a dashboard of the vehicle, a handle bar of the vehicle, a shifter of the vehicle, a roll bar of the vehicle, or a wrist of a user.

5. The system of claim 4, wherein the user interface is interchangeable between multiple mounts positioned at different locations around the vehicle.

6. The system of claim 1, wherein the modular accessory controller includes a plurality of accessory inputs for electrically coupling the modular accessory controller to the two or more accessories.

7. The system of claim 1, wherein the plurality of buttons includes one or more of a winch power-in button for powering in a rope of winch, a winch power-out button for powering out a rope of a winch, a winch freespool clutch button for adjusting a position of a winch clutch, or an activity mode selection button.

8. The system of claim 1, wherein the control interface includes one or more of a display or lights providing feedback to a user.

9. The system of claim 1, wherein the control interface provides tactile feedback to a user after selecting one of the plurality of buttons.

10. The system of claim 1, wherein the modular accessory controller is a winch controller of a winch coupled to the vehicle.

11. The system of claim 1, wherein the modular accessory controller is in communication with a vehicle controller and a winch controller of a winch coupled to the vehicle.

12. A method, comprising:
at a modular accessory controller of a powersports vehicle:
receiving a plurality of user inputs via a single control interface for adjusting operation of each of a winch and one or more accessories coupled to the powersports vehicle, the single control interface in communication with the modular accessory controller and removably coupled to the vehicle; and
sending a signal to each of the winch and the one or more accessories to adjust winch and accessory operation based on the received plurality of user inputs.

13. The method of claim 12, further comprising sending feedback to the single control interface as to a status of the winch and the one or more accessories after sending the signal to each of the winch and the one or more accessories.

14. The method of claim 12, further comprising presenting to a user a plurality of menu options via a display screen of the single control interface, the plurality of menu options selectable via one or more buttons of the single control interface.

15. A control interface for a vehicle, comprising:
a button pad removably coupled to an interface mount coupled to one or more of the vehicle or a user of the vehicle, the button pad including a plurality of buttons selectable by the user from a riding position in the vehicle to adjust operation of a winch and one or more accessories coupled to the vehicle;
a microcontroller adapted to generate a user interface at a display screen of the control interface, the user interface providing feedback to the user based on a selection of one or more of the plurality of buttons; and
a radio module in wireless communication with a control module controlling operation of the winch and the one or more accessories.

16. The control interface of claim 15, wherein the control module is a winch control module.

17. The control interface of claim 15, wherein the control module is a modular accessory control module in communication with a winch control module, a vehicle control module, and the one or more accessories.

18. The control interface of claim 15, wherein the display screen is integral with the interface mount.

19. The control interface of claim 15, wherein the display screen is mechanically coupled to the interface mount.

20. The control interface of claim 15, wherein the display screen is mounted to a vehicle remote from the interface mount and electrically coupled with the interface mount.
